(19) United States
(12) Patent Application Publication
(10) Pub. No.: US 2004/0205031 A1
(43) Pub. Date: Oct. 14, 2004

(54) Method of providing product and service pricing to promote or reward usage of the product or service

(76) Inventor: Bruce A. Cranner, Metairie, LA (US)

Correspondence Address: MICHAEL D CARBO, PLC, 700 WHITNEY BANK BUILDING, 228 ST CHARLES AVENUE, NEW ORLEANS, LA, 70130, US

(21) Appl. No.: 10/643,704

(22) Filed: Aug. 19, 2003

Related U.S. Application Data
(60) Provisional application No. 60/462,905, filed on Apr. 14, 2003.

(51) Int. Cl. G06F 17/00

(52) U.S. Cl. 705/400

(57) ABSTRACT

A method for pricing a product or service to promote or reward usage of the product or service by selecting a baseline price for a billing period; selecting a variable price per event or time period, the variable price being negative; selecting a number of events or a number of time periods; and calculating a total price per billing period. The total price is the sum of the baseline price and the product produced by multiplying the variable price and the number of events or time periods.

### CROSS REFERENCE TO RELATED APPLICATIONS

This application is a continuation-in-part of U.S. Provisional Patent Application No. 60/462,905, filed Apr. 14, 2003.

### STATEMENT REGARDING FEDERALLY FUNDED RESEARCH OR DEVELOPMENT

Not applicable.

### REFERENCE TO SEQUENCE LISTING, TABLE, OR COMPUTER PROGRAM LISTING SUBMITTED ON COMPACT DISK

Not applicable.

### FIELD OF THE INVENTION

The present invention relates to methods for providing product and service pricing to promote or reward usage of the product or service. In particular, the present invention relates to providing prices to promote or reward usage of a product or service by adding negative variable charges to a fixed charge so that the total price for increased usage of the product or service is less than the total price for lesser usage of the product or service.

### BACKGROUND OF THE INVENTION

Traditionally, price structures consist of two elements (or “tariffs”): a fixed charge, and a variable charge. (See: Walter Oi, “A Disneyland Dilemma: Two-Part Tariffs for a Mickey Mouse Monopoly,” Quarterly Journal of Economics, February 1971). Typically the fixed charges are one-time, or per period (e.g.: $80 to gain admission to Disneyland), and the variable charges are per event, use or unit of time (e.g.: $5.00 for a particular ride within Disneyland).

In some cases, the fixed charges are zero, or can even be negative, such as when long distance telephone companies send you a check to switch carriers. In some cases the variable charges are zero, in which case it the price is known as “flat fee” and the initial charge is the entire amount charged, e.g.: a monthly subway or railroad pass.

In no case we know of is the variable charge negative. Also, there is no clear link between the fixed charge and the variable charge.

### OBJECTS OF THE INVENTION

The method of the invention is a new pricing method, which allows companies to offer services and goods for a price which is defined by user behavior, so that users have explicit incentives to try, and use, the service as much as they like. Unlike loss-leaders or up-front inducements, this price structure directly links the discount to the usage in a novel way. The benefit is that there is a clearer incentive for purchasers to use the service. Another major advantage is that sellers can promote a service or product as potentially free, but still obtain revenues should buyers fail to use the service or product.

The pricing scheme inverts the commonly used pricing scheme of “the more you use, the more you pay,” and instead says “the more you use, the less you pay.” This is not to be confused with the commonly used scheme where “the more you use, the less you pay (i.e.: the smaller the additional or average increment) for each additional use.”

### SUMMARY OF THE INVENTION

The method may have two elements:

1) A set of relationships, described below, between the fixed charge and the variable charge, and

2) The use of a negative number as the variable (per event) price.

An essential definition of this patent is that the price structure described relates to what can be called “a billing period.” A billing period is a recognizable period in which a user or purchaser, and the seller of the service or product, reconcile amounts owed, and make arrangements for payment, settlements or accounting period closure.

There may be a longer term relationship beyond the billing period, such as a long term contract or other obligation, but this consists of multiple billing periods unless the contract calls only for payment (e.g.) at the end of the contract.

The pricing method establishes a relationship between the total price for one billing period that can be described through five terms:

The term “y” is the balance due from the customer for the billing period

The term “m” is the variable charge, or the amount which the balance due from the customer declines in value (per event or use, or per time period) within the billing period.

The term “x”, which is the number of actual chargeable events, or measured time periods, within the billing period.

The term “n” which is the expected number of events, based on forecast or (if events include the passage of time) based on the calendar.

The term “b” is the fixed (or baseline) charge for the billing period, before the chargeable events occur or periods of time pass.

Symbolically, a price can be described as:

y=mx+b

The two innovative elements of the patent are as follows:

1) For “m” a negative dollar amount. This amount may be constant, or may change either:

According to a set taper, or

According to the number of uses (the “x”) such that the absolute value of the product of m and x never exceed “b” or another target.

2) In use, “m” may be related to “b”. This relationship may be that the absolute value of “m” equals b/n, where n is the expected number of likely uses of a service or purchases of a product. Also, a taper may be superimposed on the value of b/n, so that the average value of “m” equals the absolute value of b/n.

Frequently “n” might also be the number of commonly used time periods within a billing period:

Seven, the number of days in a week

Twenty or Twenty one, the number of working days typically in a month

Twelve, the number of months in a year, or

Twenty four, the number of hours in a day,

Sixty, the number of minutes in an hour, etc.

The values of “m” are related to “x”, which will be a positive number measurable in time, events or from customer behavior, e.g. the number of times they log onto an internet service. This number may be capped or altered by formula so that the absolute value of mx does not exceed “b”, or does not exceed “b” by more than a specified amount.

The above description sets forth rather broadly the essential features of the present disclosure so that the detailed description that follows may be better understood, and so that the present contributions to the art may be better appreciated. There are, of course, additional features of the disclosure that are described herein which will form the subject matter of the claims appended hereto. In this respect, before explaining embodiments of the disclosure in detail, it is to be understood that the disclosure is not limited in its application to the details set forth in the following description or illustrated in the drawing. The present invention is capable of other embodiments and of being practiced and carried out in various ways, as will be appreciated by those skilled in the art. Also, it is to be understood that the phraseology and terminology employed herein are for description and not limitation.

### BRIEF DESCRIPTION OF THE DRAWING FIGURE

FIG. 1 is a flowchart illustrating the establishment of a total price for services or products used during a billing period, which total price includes a negative per-use charge based on the number of uses of the services or products.

### DETAILED DESCRIPTION

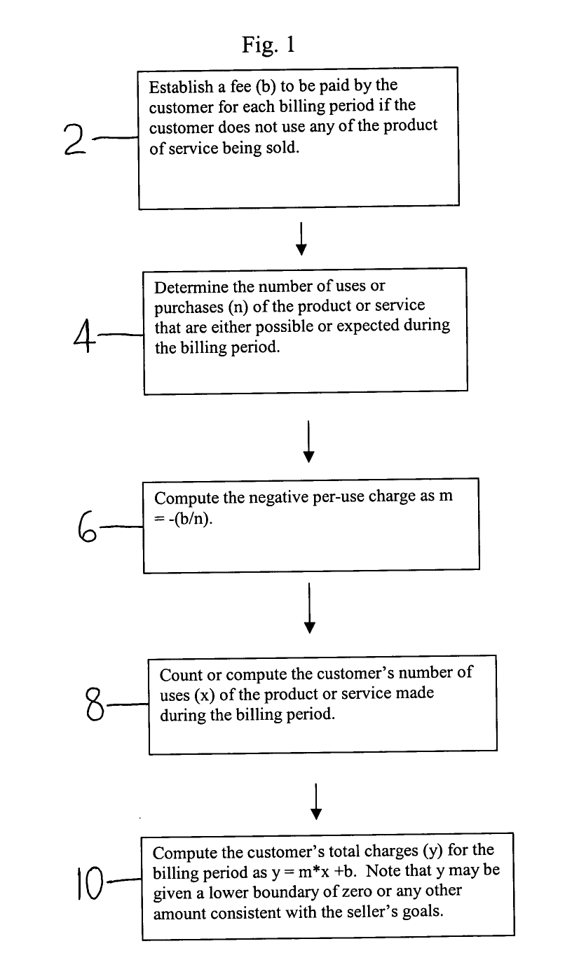

Turning now to the drawing, FIG. 1 is a flowchart illustrating the various steps of an embodiment of the method for providing product and service pricing to promote or reward usage of the product or service. At 2, a fee (b) is established to be paid for each billing period if the customer does not use any of the product or service being offered. At 4, a determination is made of the number (n) of uses or purchases of the product or service that are either possible or expected during the billing period. At 6, a negative per-use charge m, where m=−b/n, is computed. At 8, a count or computation is made of the number of uses (x) that the customer made of the product or service during the billing period. At 10, the customer's total charges (y) are computed for the billing period using the formula y=(m times x)+b.

Note that y may be assigned a lower boundary of zero or any other amount consistent with the seller's goals.

A preferred example of the method of the invention in practice for the above-described steps comprises providing an on-line information service. For an on-line information service, the fixed charge is $2,100 per month. A month is the billing period. A chargeable event would be every time a user of the service logs into the online service. There is only one chargeable event per business day, so there are usually a maximum of 21 chargeable events per month.

In this case, the charge for every day which includes a log-in is ($100.00), i.e. negative one hundred dollars.

Thus, if a user of the service logs in all 21 days in a particular month, his/her charges for the billing period will net to zero, i.e.:

$0.00=[(−$100.00)×21 days]+$2,100.00

Note that the price structure of the preferred example differs intrinsically from the following three examples of existing types of price structures.

First, many price structures reduce billing amounts or provide rewards only over multiple billing—periods not within a single period. For instance, popular frequent-flier incentives require you to buy a ticket and fly before obtaining your reward: only afterwards do you get a something of value (points, miles, or free tickets). Investments are another example: the rewards, (hopefully) obtain positive cash flows arising from the initial investment, do not arrive until after the initial investment.

Second, cumulative discounts may reduce the “m” (variable charge) values over time. But “m” remains still positive for these existing cumulative discounts, whereas m becomes negative in the preferred example of the pricing structure. Further, existing cumulative discounts often span multiple billing periods.

Third, “two for one” or similar discounts can be read in a number of ways, but none matches the structure being patented because none includes a negative variable charge “m.” A typical interpretation of a “two for one” is that the second unit is free or zero value (not negative). Another interpretation is that there is no price change, merely that the definition of the unit of sale has moved from one physical item to two.

The pricing method described above can be embedded into a more complex pricing method. Thus the price for a bundle of goods or services (Y total), could contain some elements that fit the structure being patented:

Y total=[m1×1]+b1 plus [m2×2]+b2, etc.

And perhaps the first element (1) might fit the structure, while other elements (2, etc.) might not. Similarly, a complex price formula for one good or service might have this pattern.

This pricing scheme is applicable to a wide range of offers where the service provider or manufacturer wishes to promote usage, particularly repeat usage:

Services and Services:

Online services, such as information services, or internet entertainment services, such as legal information systems, can have a two-part billing: a monthly subscription, and a (negative) usage charge for particular files.

New services and products being offered to market are particularly suitable for this kind of pricing. A service could be priced so that at maximum usage, it costs nothing or even a negative amount. If there is less than maximum usage, the company would obtain positive revenues. This is particularly likely with low-variable-cost services.

Services which include customer usage which is not a good thing for the buyer could use this scheme to help offset the bad-event usage, e.g.: a burglar alarm company could sell a maintenance contract where cost of a visit is actually a reduction from the monthly fee (“b”).

Services where usage is a good thing for both provider and purchaser, e.g.: a leasor of cars pays lessees of those cars a payment for every oil change during the lease billing period. This preserves the car's value, and makes it run better.

Products and Products

Many manufactured goods have a machine, plus disposable attachments. Examples include a water purifier that uses filters, or a gasoline engine that uses oil filters.

Manufactured goods, particularly where the variable cost of manufacture is low relative to market prices. Examples include disposable goods, such as paper ware, plastic containers, which might be sold by the case.

Products and Services

In many cases a service is embedded into a product, such as a television set and the watching of programs on Cable TV or satellite dish. Where a television is bought on monthly payments, and viewing can be monitored, a linkage between television set and program source could result in a reduced payments (viewing as the “m”) to the television payments. The above examples are not meant to be comprehensive.

This pricing structure is particularly advantaged when the activity (“m”) being compensated for also holds economic advantage to the seller. Examples of such advantage might include:

A package delivery service which wishes customers to use their standard packaging. Such a delivery service might simply insist on it to the applicant's knowledge (none do), but a better way would be to pay them for use of service-provided packaging. This might allow the service less breakage, better handling, and better use of airplane cargo spaces.

A membership retailer, like Sams Club or Costco, who wishes to encourage shoppers to visit all the isles in its store may pay money for such visits during a billing period.

A health insurer, such as an employee HMO, which believes its costs are lower if certain members come in and are supervised in the taking of certain medicines. Such an HMO might provide an offset to its quarterly charge to the employer for each visit by the HMO member/employee to take the medicine.

Industries where this pricing structure might be particularly advantaged include online information services, entertainment and recreation, consumer durables, transportation, insurance, healthcare, industries with rapid product and service turnover.

1. A method for pricing a product or service to promote or reward usage of the product or service, the method comprising:
selecting a baseline price for a billing period;
selecting a variable price per event or time period, the variable price being negative;
selecting a number of events or a number of time periods;
calculating a total price per billing period.

2. The method according to claim 1,
wherein the total price is the sum of the baseline price and the product produced by multiplying the variable price and the number of events or time periods.

3. The method according to claim 2,
wherein the absolute value of product of the variable price and the number of events or time periods is less than or equal to the baseline price.

4. The method according to claim 3,
wherein the absolute value of the product of the variable price and the number of events or time periods is equal to the baseline price.

5. The method according to claim 2,
wherein the absolute value of the product of the variable price and the number of events or time periods is less than the baseline price.

6. The method according to claim 2,
wherein the absolute value of the product of the variable price and the number of events or time periods is greater than the baseline price.
